(19) United States
(12) Patent Application Publication
(10) Pub. No.: US 2026/0063352 A1
(43) Pub. Date: Mar. 5, 2026

(54) VARIABLE BI-DIRECTIONAL AIRFLOW SYSTEM AND METHOD FOR A THERMAL PROCESSING MACHINE

(71) Applicant: JBT MAREL CORPORATION, Chicago, IL (US)

(72) Inventors: Cory N. Osborne, North Ridgeville, OH (US); Stephen M. Hanna, Norwalk, OH (US); Ramesh M. Gunawardena, Solon, OH (US)

(73) Assignee: JBT MAREL CORPORATION, Chicago, IL (US)

(21) Appl. No.: 18/824,704

(22) Filed: Sep. 4, 2024

(51) Int. Cl. F25D 13/06; A23L 3/36; B65G 21/18

(52) U.S. Cl. CPC F25D 13/067; B65G 21/18; A23B 2/803; B65G 2201/0202; B65G 2207/24; F25D 2317/063

(57) ABSTRACT

A variable bi-directional airflow thermal processing system may include a thermal processing medium supply for substantially horizontally supplying thermal processing medium to the thermal processing chamber at a target temperature and velocity and a thermal processing medium directing assembly configured to divide the spiral stack into at least one treatment zone and at least one return zone both extending along a height of the spiral stack and substantially confined within a footprint of the spiral stack, wherein the thermal processing medium supply substantially horizontally supplies thermal processing medium to the at least one treatment zone and substantially horizontally withdraws thermal processing medium from the at least one return zone.

### BACKGROUND

Spiral conveyor-based thermal processing systems include a cooling/freezing surface, proofing surface or a cooking surface in the form of a pervious conveyor belt for conveying workpieces, including food, through a thermal processing chamber in a spiral or helical path. If the workpiece is being cooled or frozen, a source of cooling medium is provided either within the cooling/freezing chamber or adjacent thereto. Correspondingly, if thermal processing is in the form of cooking or otherwise heating, a heat source, such as steam, air, or mixtures thereof, is provided within or adjacent to the cooking chamber for cooking the workpieces.

An advantage of thermal processing systems utilizing spiral conveyor belts is that a relatively long processing path can be achieved with a small footprint. For example, a 600-foot-long thermal processing conveyor belt in a spiral configuration can be contained within a 20-foot×20-foot×20-foot housing. However, spiral stack conveyor thermal processing systems do have inherent drawbacks from a linear freezer of a comparable length. In a linear freezer, the upper and lower surfaces of the products are efficiently impinged upon by the thermal processing medium. However, in a spiral freezer, the workpiece is not as directly accessible to the thermal processing medium since the work products are arranged in stacked layers, thus requiring less direct thermal processing methods than direct impingement of the thermal processing medium onto the food product.

In one known spiral stack conveyor thermal processing system, a fan system is used to direct the flow of the thermal processing medium (e.g., cooled air) vertically through the annulus of the spiral conveyor, either in the upward or downward direction, as well as to some extent horizontally across the layers of the spiral stack. One difficulty in this type of thermal processing medium flow arrangement is to achieve uniform thermal processing across the conveyor since typically the food product is arranged in multiple lanes with variable spacing along the conveyor. When the conveyor belt is in straight configuration, the food products can be fairly uniformly spaced across and along the conveyor. However, when the conveyor curves into a spiral, the food products on the inside of the conveyor become relatively closer together, whereas the food products on the outside of the conveyor become relatively further apart. As such, the food products on the inside of the conveyor tend to receive less thermal processing medium per food product relative to the food products located on the outside of the conveyor. As such, attempts have been made to direct at least some of the thermal processing medium across the levels or flights or tiers of the conveyor, typically from the outside toward the center of the spiral.

Other techniques that have been employed in an effort to more uniformly thermally treat food products in a spiral stack conveyor include reversing the direction of flow of the thermal treatment medium while the food product is moving along the spiral conveyor. For example, during part of the processing cycle, the thermal processing medium may be directed upwardly through the annulus of the spiral, and then later in the cooking process, the direction of flow of the thermal processing medium may be reversed to flow from the top of the conveyor stack down.

Another effort in achieving more uniform thermal processing is to employ baffles or mezzanines around and/or within the center of the spiral conveyor to control the direction of the thermal processing medium flow through the spiral stack. In this regard, fixed inner mezzanines have been positioned with the center of the spiral stack to essentially divide the spiral stack into two different thermal processing zones. For example, a first thermal processing zone may be at a higher pressure, and a second thermal processing zone may be at a lower pressure.

A further effort to achieve more uniform and effective thermal treatment of food products is to employ tubes or nozzles that extend laterally between layers or tiers of the spiral stack, and thereby direct the thermal processing medium downwardly or upwardly toward the food product being carried on the spiral conveyor. This is an attempt to incorporate an impingement type system into a spiral stack thermal processing apparatus. Of course, this system requires a more complicated structure, which structure must be maintained in sanitary conditions, and thus requires periodic cleaning. The cleaning process is time consuming, thereby reducing the potential operating time of the thermal processing system.

The present disclosure seeks to provide an improved system and method for thermally processing work products, including food products, while being transported on a conveyor disposed into a spiral stack.

### SUMMARY

In some aspects, the techniques described herein relate to a variable bi-directional airflow thermal processing system for a spiral conveyor configured in at least one spiral stack enclosed within a thermal processing chamber having in inlet and an outlet, the spiral conveyor entering the thermal processing chamber via the chamber inlet and exiting the thermal processing chamber via the chamber outlet, the variable bi-directional airflow thermal processing system including: a thermal processing medium supply for substantially horizontally supplying thermal processing medium to the thermal processing chamber at a target temperature and velocity; and a thermal processing medium directing assembly configured to divide the spiral stack into at least one treatment zone and at least one return zone both extending along a height of the spiral stack and substantially confined within a footprint of the spiral stack, wherein the thermal processing medium supply substantially horizontally supplies thermal processing medium to the at least one treatment zone and substantially horizontally withdraws thermal processing medium from the at least one return zone.

In some aspects, the techniques described herein relate to a variable bi-directional airflow freezer system for a spiral conveyor configured in at least one spiral stack enclosed within a freezer chamber having in inlet and an outlet, the spiral conveyor entering the freezer chamber via the chamber inlet and exiting the freezer chamber via the chamber outlet, the variable bi-directional airflow freezer system including: a cooling medium supply for substantially horizontally supplying cooling medium to the freezer chamber at a target temperature and velocity; a cooling medium directing assembly configured to divide the spiral stack into at least an infeed treatment zone, an outfeed treatment zone, and a return zone each extending along a height of the spiral stack and substantially confined within a footprint of the spiral stack, wherein the infeed treatment zone includes a portion of the spiral conveyor entering the freezer chamber via the chamber inlet, the outfeed treatment zone includes a portion of the spiral conveyor exiting the freezer chamber via the chamber outlet, and the return zone includes a portion of the spiral conveyor extending between the infeed and outfeed treatment zones; wherein the cooling medium supply substantially horizontally supplies cooling medium to the infeed and outfeed treatment zones and substantially horizontally withdraws cooling medium from the at least one return zone.

In some aspects, the techniques described herein relate to a spiral conveyor freezer, including: a freezer chamber having an inlet and an outlet; a spiral conveyor configured in at least one spiral stack enclosed within the freezer chamber, the spiral conveyor entering the freezer chamber via the chamber inlet and exiting the freezer chamber via the chamber outlet; a cooling medium supply for substantially horizontally supplying cooling medium to the freezer chamber at a target temperature and velocity; and a cooling medium directing assembly configured to divide the spiral stack into at least an infeed treatment zone, an outfeed treatment zone, and a return zone each extending along a height of the spiral stack and substantially confined within a footprint of the spiral stack, wherein the infeed treatment zone includes a portion of the spiral conveyor entering the freezer chamber via the chamber inlet, the outfeed treatment zone includes a portion of the spiral conveyor exiting the freezer chamber via the chamber outlet, and the at least one return zone includes a portion of the spiral conveyor extending between the infeed and outfeed treatment zones, wherein the cooling medium supply substantially horizontally supplies cooling medium to the infeed and outfeed treatment zones and substantially horizontally withdraws cooling medium from the at least one return zone.

In some aspects, the techniques described herein relate to a method of treating work products in spiral conveyor freczer having a spiral conveyor configured in a spiral stack and enclosed within a freezer chamber, the method including: supplying work products to the spiral conveyor through a freezer chamber inlet; supplying a cooling medium to the freezer chamber at a target temperature and velocity; flowing the cooling medium substantially horizontally into an infeed treatment zone extending along a height of the spiral stack at an infeed end of the spiral conveyor; flowing the cooling medium substantially horizontally into an outfeed treatment zone extending along a height of the spiral stack at an outfeed end of the spiral conveyor; and substantially horizontally withdrawing cooling medium from at least one return zone extending along a height of the spiral stack and including a portion of the spiral conveyor extending between the infeed and outfeed treatment zones.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing aspects and many of the attendant advantages of this invention will become more readily appreciated as the same become better understood by reference to the following detailed description, when taken in conjunction with the accompanying drawings, wherein:

FIG. 1 is an isometric view of an exemplary freezer system having a variable bi-directional airflow thermal processing system formed in accordance with examples herein.

FIG. 2 is an isometric view of the exemplary freezer system and variable bi-directional airflow thermal processing system of FIG. 1, with a majority of a freezer housing removed.

FIG. 3 is a cross-sectional view of the exemplary freezer system and variable bi-directional airflow thermal processing system of FIG. 2, with the cross-section taken along the length of the freezer system, wherein airflow through the system is graphically depicted.

FIG. 4 is a side view of the cross-sectional view of the exemplary freezer system and variable bi-directional airflow thermal processing system of FIG. 3, wherein airflow through the system is graphically depicted.

FIG. 5 is a top view of the exemplary freezer system and variable bi-directional airflow thermal processing system of FIG. 1, wherein a ceiling of the freezer housing has been removed, and wherein airflow through the system is graphically depicted.

FIG. 6 is another representative side view of the cross-sectional view of the exemplary freezer system and variable bi-directional airflow thermal processing system of FIG. 3, wherein airflow through the system is graphically depicted.

FIG. 7 is a top view of the exemplary freezer system and variable bi-directional airflow thermal processing system of FIG. 6, wherein a ceiling of the freezer housing has been removed.

FIG. 8 shows a graphical image of expected face airflow velocities through evaporator coils of an exemplary variable bi-directional airflow thermal processing system formed in accordance with examples herein, based on a CFD analysis.

FIG. 9 shows a graphical image of expected airflow velocities through various tiers of a freezer chamber of an exemplary variable bi-directional airflow thermal processing system formed in accordance with examples herein, based on a CFD analysis.

FIG. 10 shows an expected airflow velocity through a representative tier of a prior art freezer vertical airflow design, based on a CFD analysis.

FIG. 11 shows an annotated graphical depiction or curve of a typical food freezing process based on known principles of heat transfer, with temperature on the y-axis and time on the x-axis.

FIG. 12 is a representative side view of a cross-sectional view of another exemplary freezer system and variable bi-directional airflow thermal processing system, wherein airflow through the system is graphically depicted.

FIG. 13 is a is a flowchart that illustrates a non-limiting example embodiment of a method of performing variable bi-directional airflow thermal processing according to various aspects of the present disclosure.

### DETAILED DESCRIPTION

Examples of the present disclosure are directed to variable bi-directional airflow thermal processing systems and methods. The variable bi-directional airflow thermal processing systems and methods may be used for optimizing the thermal processing of work products in spiral conveyor-based thermal processing systems. For instance, heat transfer between the work product and the thermal processing medium (e.g., air or gas) can be maximized by tailoring treatment of the work product to its stage in the thermal process (e.g., freezing stage, cooking stage, etc.). Maximizing heat transfer increases the efficiency of the thermal process, which can decrease thermal processing dwell times, decrease product dehydration, and decrease energy consumption, among other benefits.

Using the variable bi-directional airflow thermal processing systems and methods described herein, heat transfer also occurs more uniformly across the work products in the system. If the work products are more consistently frozen during the freezing process, it would (lower the standard deviations of substrate temperatures exiting the freezer), thereby improving overall work product quality with reduced dwell times and yield increases.

The variable bi-directional airflow thermal processing systems and methods described herein also support thermal processing flexibility. For instance, the variable bi-directional airflow systems and methods support work product movement from a bottom to a top of a spiral stack and from a top to a bottom of a spiral stack without altering the airflow design. These and other benefits will become further appreciated from the description that follows.

Exemplary variable bi-directional airflow thermal processing systems and methods will be shown and described with reference to a freezer for cooling/freezing food products. However, it should be appreciated that the systems and methods described herein may be adapted for use with other thermal treatment systems, such as proofing applications, drying applications, heating applications, etc.

References to “work product”, “work piece”, “food item”, “food product”, “product”, or the like may be used synonymously. One example of a work product or workpiece is a food product, such as, for example, beef, pork, poultry, fish, vegetables, fruits, bakery items, and nuts.

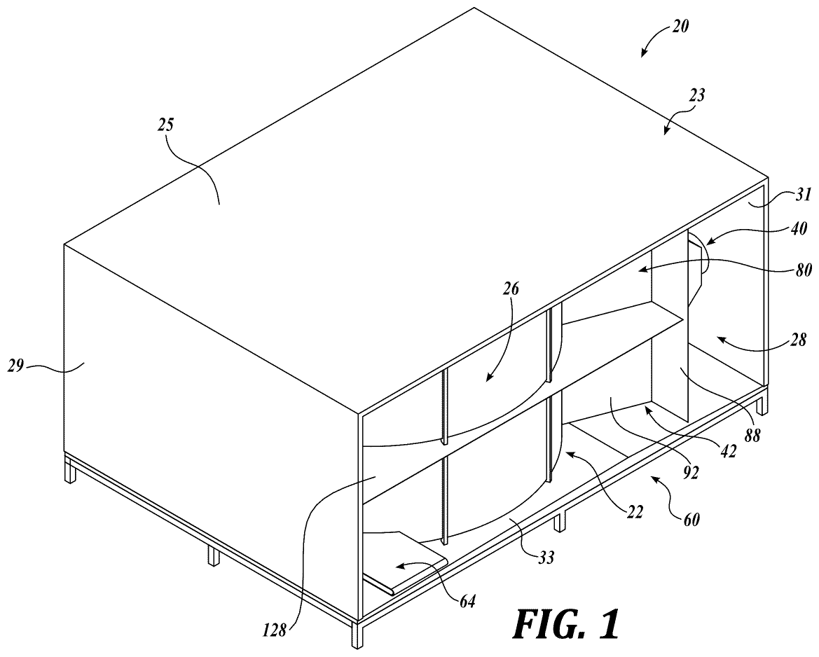

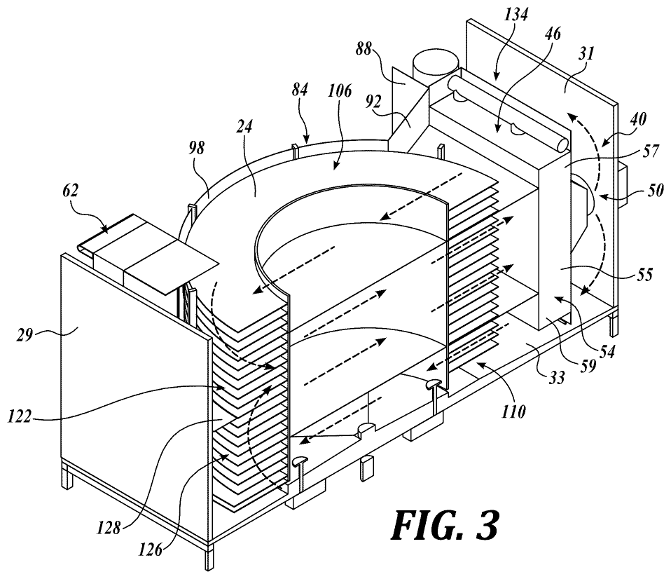

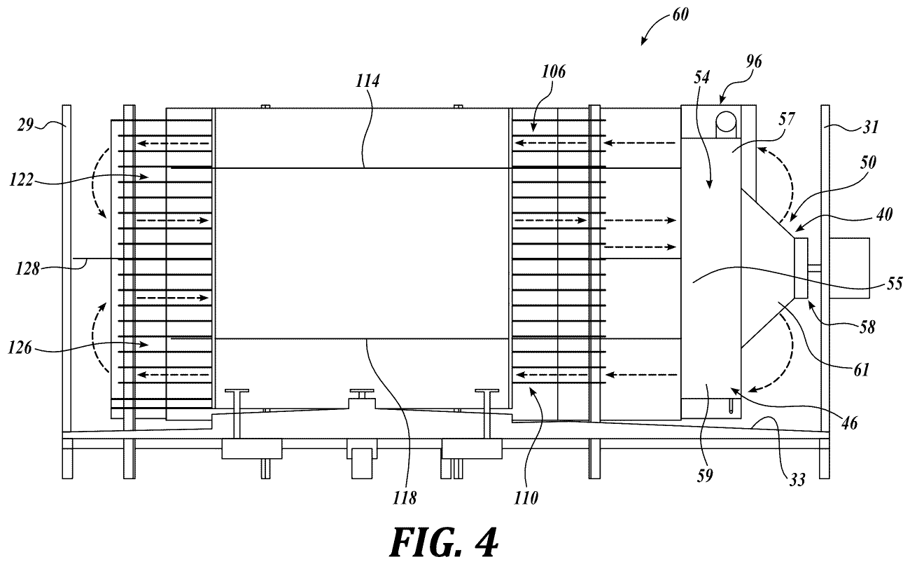

An exemplary freezer system 20 configured for use with the variable bi-directional airflow thermal processing systems and methods described herein will now be described with reference to FIGS. 1-5. The freezer system 20 includes a spiral conveyor system 22 housed within a rectangularly shaped housing 23 defining a thermal processing chamber or a freezer chamber 28. The rectangularly shaped housing 23 includes a top section or ceiling 25, longitudinal side sections or walls 27, a front transverse end section or wall 29, a back transverse end section or wall 31, and bottom section or floor 33.

The spiral conveyor system 22 includes a conveyor belt 24 that is configured into an ascending or descending spiral stack 26. The conveyor belt 24 supports and transports workpieces/food products through the spiral stack 26. When formed as a spiral stack 26, the conveyor belt 24 is coiled in a generally spiral configuration to form a plurality of spiral tiers 34 stacked one above the other. In some examples, sidewall portions of each tier 34 form a substantially continuous inner cylindrical wall-like surface and outer cylindrical wall-like surface. The spiral stack 26 may have any number of tiers 34, and in the case of industrial freezer, typically in the range of about thirty to about forty-five tiers.

In the example shown, the exemplary freezer system 20 includes an inlet that receives an infeed 62 leading into an upper end of the freezer chamber 28 and in communication with an uppermost tier 34 of the spiral stack 26. An outlet in the freezer chamber 28 receives an outfeed 64 that extends from a lower end of the freezer chamber 28 and is in communication with a lowermost tier 34 of the spiral stack 26. In that regard, the exemplary freezer system 20 is configured to support work product movement from the top of the spiral stack 26 to the bottom of the spiral stack. However, as noted above, the variable bi-directional airflow thermal processing systems and methods described herein may be used with a system that 20 is configured to support work product movement from the bottom of the spiral stack 26 to the top of the spiral stack. Thus, the infeed 62 and outfeed 64 may instead be reversed.

Suitable examples of spiral self-stacking conveyor belts are also shown and described in U.S. Pat. No. 3,938,651, entitled “Self-supporting spiral conveyor”, U.S. Pat. No. 5,803,232, entitled “Conveyor belt”, and U.S. Pat. App. Pub. No. US20080302638A1, entitled “Supporting Installation”, the disclosures of which are hereby expressly incorporated by reference. However, other suitable spiral belt assemblies are also within the scope of the present disclosure.

The exemplary freezer system 20 further includes a thermal processing medium supply or a gas treatment system 40 configured to deliver a gaseous cooling medium to food products or other workpieces disposed on the spiral stack 26. The gas treatment system 40 circulates the cooling medium within the freezer chamber 28. A thermal processing medium directing assembly or airflow directing assembly 42, as described in greater detail below, divides the spiral stack 26 and the freezer chamber 28 into a plurality of processing zones or segments.

The gas treatment system 40 may include an evaporator assembly 46 and a gas circulation assembly 50 located near a transverse end wall 29 of the rectangularly shaped housing 23. The evaporator assembly 46 may be any assembly configured to suitably cool air after it has passed through product treatment zones defined by the spiral stack 26 and the airflow directing assembly 42. After passing through the evaporator assembly 46, the cooled air may be recirculated to a product treatment zone for treatment of the workpieces disposed on the spiral stack 26. In that regard, the evaporator assembly 46 has a suitable capacity to supply a necessary volume of cooled air to the treatment zones for the intended application.

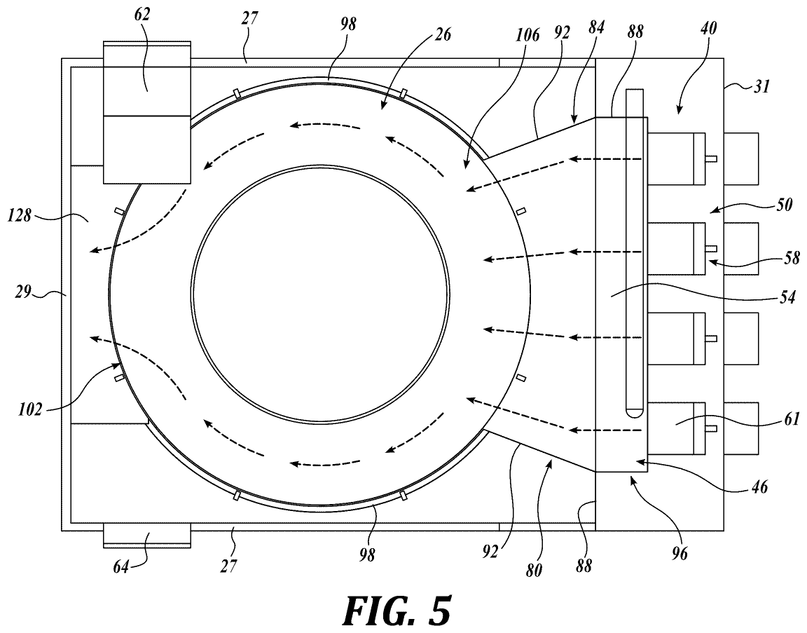

In the depicted example, the evaporator assembly 46 is a collection of a suitable number of evaporator coils 54 (such as four coil assemblies, as represented in FIG. 5) for providing cooled air flow throughout the product treatment zones. The evaporator coils 54 may be substantially evenly spaced across the width of the freezer chamber 28 between longitudinal side walls 27 of the rectangularly shaped housing 23. The evaporator coils 54 may extend substantially along the height of rectangularly shaped housing 23 between the ceiling 25 and floor 33.

A suitable gaseous cooling medium in accordance with examples of the present disclosure may be composed of air at a predefined operating temperature. By way of example, the temperature of the gaseous cooling medium may be in the range of 110° F.-60° F. Other fluids or gases may also be used. For example, nitrogen or carbon dioxide may be used for treatment of sensitive products requiring treatment in a protected atmosphere. Therefore, the terms “cooling medium”, “cooling air”, “gaseous cooling medium”, “gas”, “air”, “dry air”, “fluid”, etc., may be used interchangeably throughout the present disclosure. Moreover, as noted above, the variable bi-directional airflow thermal processing systems and methods described herein may be adapted for use with other thermal treatment systems, such as proofing applications, drying applications, heating applications, etc. Thus, in such other applications, the gas treatment system and the type of thermal processing medium used may be another suitable type (e.g., heated air/gas, steam, etc.).

The gas circulation assembly 50 is configured to circulate gaseous cooling medium (or simply “air”) from the evaporator assembly 46, through product treatment zones, and back to the evaporator assembly 46 for cooling. In the depicted example, the gas circulation assembly 50 is a collection of a suitable number of air movement devices for circulating cooled air into the product treatment zones and back to the evaporator assembly 46. In the example shown, the gas circulation assembly 50 includes a plurality of fan wheels 58 located near the back transverse end wall 31. The fan wheels 58 are substantially evenly spaced across the width of the freezer chamber 28 between the longitudinal side walls 27, generally in alignment with the evaporator coils 54. The fan wheels 58 are also substantially centered along the height of the evaporator coils 54 (and in alignment with a return zone, as will be described below). A fan shroud 61 or the like may be disposed between each of the fan wheels 58 and the corresponding evaporator coils 54. Any other suitable arrangement of evaporator coils and air movement devices (e.g., fans) may instead be used.

As noted above, in some traditional prior art spiral conveyor configurations, a fan system is used to direct the flow of thermal processing medium across a vertical plane, hitting all tiers of the spiral evenly. Such a traditional horizontal airflow design is well balanced, but it can be inefficient because it does not optimize the freezing process.

For instance, traditional over/under spiral conveyor airflow designs target the high side or low side of the spiral with the coldest air. The coldest air is directed to only an upper or lower portion of the stack on one side of the stack, so the coldest air only reaches about half of the topmost or bottom most tiers. Such a design is inefficient due to the large volume of space that the incoming air covers. It also leads to the creation of dead zones where little airflow occurs in parts of the spiral.

In accordance with the variable bi-directional airflow thermal processing systems and methods disclosed herein, the uppermost and lowermost tiers are targeted with the coldest, highest velocity air in a horizontal plane, resulting in maximum heat transfer. In other words, the entirety of the first and last few tiers (or upper and lower most tiers) will be covered with cold, high velocity air. Targeting these zones ensures that maximum heat transfer occurs as quickly as possible, and product leaving the spiral is at its coldest temperatures for shipping/storage needs.

The variable bi-directional airflow thermal processing systems and methods disclosed herein also enable maximization of heat transfer between the work product and the gaseous cooling medium by tailoring treatment of the work product to its stage in the freezing process. According to known principles of thermodynamics, maximum heat transfer occurs when a temperature difference between a moving fluid and the collective sum of the individual products' surface temperatures are the greatest. Incoming products are at their highest temperatures immediately upon entering a freezer, and the air is coldest just after leaving a heat exchanger (e.g. an evaporator).

Using the variable bi-directional airflow thermal processing systems and methods disclosed herein, air leaving the evaporator is directed towards the infeed, whether at the upper or lower end of the spiral stack, to maximize heat transfer with the high temperature products. In that regard, weighted averages of the log mean temperature differentials between the circulating dry air and product surface temperatures can be substantially increased to thereby improve energy transfer and remove heat from product through all stages of the process.

A first example of a variable bi-directional airflow thermal processing system 60 configured to maximize heat transfer and tailor treatment of a work product to its stage in the freezing process will now be described with reference to FIGS. 1-5. Generally, the variable bi-directional airflow thermal processing system is defined by the spiral stack 26 having an infeed 62 and an outfeed 64 leading into and out of the freezer chamber 28, the airflow directing assembly 42 configured to divide the spiral stack 26 and the freezer chamber 28 into a plurality of airflow processing zones or segments, and the gas treatment system 40 configured to horizontally direct a required amount of cold, high velocity air to processing zones defined along the height of the spiral stack 26 to maximize heat transfer in accordance with the freezing stages of the product.

In the example shown, the infeed 62 is located at an upper end of the spiral stack 26, and the outfeed 64 is located at a lower end of the spiral stack to define a descending spiral configuration. However, as noted above, the variable bi-directional airflow thermal processing system 60 is configured to support thermal processing flexibility. In one aspect, the variable bi-directional airflow thermal processing system 60 supports work product movement from a bottom to a top of a spiral stack and from a top to a bottom of a spiral stack without altering the airflow design. In that regard, the infeed may instead be located at a lower end of the spiral stack 26 and the outfeed located at an upper end of the spiral stack to define an ascending spiral configuration, and the general structure of the variable bi-directional airflow thermal processing system 60 would remain the same. Thus, the variable bi-directional airflow thermal processing system 60 may be used with either a descending or ascending spiral configuration with little to no modification. Exemplary aspects of the variable bi-directional airflow thermal processing system 60 will only be described with reference to a descending spiral configuration for brevity.

Aspects of the airflow directing assembly 42 configured to divide the spiral stack 26 and the freezer chamber 28 into a plurality of airflow processing zones or segments will now be described. The airflow directing assembly 42 includes a plurality of airflow directing panels or baffles strategically positioned within the freezer chamber 28 to direct airflow to and from the gas treatment system 40. The airflow directing panels or baffles may made from any suitable impermeable or semi-permeable, food-grade material, such as stainless steel.

In a first aspect, the airflow directing assembly 42 includes a plurality of vertical baffles configured to direct airflow from the gas treatment system 40 toward the spiral stack 26 while substantially preventing air from flowing outside lateral portions of the stack. In the example shown, the gas treatment system 40 is positioned near the back transverse end wall 31 of the rectangularly shaped housing 23 opposite the infeed 62 and outfeed 64. In that regard, the infeed 62 and outfeed 64 may be positioned near the front transverse end wall 29.

A first lateral vertical baffle 80 extends from the gas treatment system 40 toward the spiral stack 26 and along a lateral portion of the stack between the stack and a first longitudinal side wall 27. A second vertical baffle 84 extends from the gas treatment system 40 toward the spiral stack 26 and along a lateral portion of the stack between the stack and a second opposite longitudinal side wall 27. The first and second lateral vertical baffles 80 and 84 both extend vertically along substantially the full height of the freezer chamber 28, e.g., between the ceiling 25 and floor 33 of the rectangularly shaped housing 23. The first and second lateral vertical baffles 80 and 84 are substantially identical and mirrored in configuration. Thus, only details of the first lateral vertical baffle 80 will be described.

The first lateral vertical baffle 80 includes a first vertical baffle portion 88 extending substantially transversely from the first longitudinal side wall 27 to a second vertical baffle portion 92. The first vertical baffle portion 88 intersects the second vertical baffle portion 92 at an end of the gas treatment system 40. In the depicted example, the gas treatment system 40 includes a substantially rectangular, open-ended housing or gas treatment system baffle assembly 96 configured to enclose the evaporator coils 54. Similar to the first and second lateral vertical baffles 80 and 84, the gas treatment system baffle assembly 96 extends vertically along substantially the full height of the freezer chamber 28, e.g., between the ceiling 25 and floor 33 of the rectangularly shaped housing 23. A closed end of the gas treatment system baffle assembly 96 contains the fan wheels 58. An open end of the gas treatment system baffle assembly 96 faces the spiral stack 26. The intersection of the first and second vertical baffle portions 88 and 92 may be along a vertical edge of the gas treatment system baffle assembly 96 at its open end.

In the depicted example, the width of the gas treatment system baffle assembly 96 is almost as wide as the spiral stack 26. The second vertical baffle portion 92 extends from the vertical edge of the gas treatment system baffle assembly 96 toward the spiral stack 26 generally along a radius of the spiral stack. The second vertical baffle portion 92 of the second lateral vertical baffle 84 is mirrored in configuration relative to the second vertical baffle portion 92 of the first lateral vertical baffle 80. In that manner, the second vertical baffle portions 92 of the first and second lateral vertical baffles 80 and 84 essentially define a nozzle extending along the height of the freezer chamber 28, directing pressurized, cold air from the gas treatment system 40 to the spiral stack 26.

The second vertical baffle portion 92 extends toward the spiral stack 26 and intersects a third vertical baffle portion 98 of the first lateral vertical baffle 80. The third vertical baffle portion 98 generally has a shape that follows the contour or circumference of the exterior of the spiral stack 26. In that regard, the third vertical baffle portion 98 may be spaced apart from and generally the same circular shape as the outer cylindrical shape of the spiral stack 26.

The third vertical baffle portion 98 extends along the circumference of the exterior of the spiral stack 26 towards the front transverse wall 29. The third vertical baffle portion 98 terminates short of a front end of the spiral stack 26. In other words, with the third vertical baffle portion 98 of the second lateral vertical baffle 84 in mirrored in configuration relative to the third vertical baffle portion 98 of the first lateral vertical baffle 80, a circumferential vertical baffle gap 102 extends along the front end of the spiral stack 26. In this manner, air may be directed from the gas treatment system 40 toward and across the spiral stack 26, and the air may exit the circumferential vertical baffle gap 102 for return to the gas treatment system 40 and/or for circulation to other portions of the stack.

The airflow directing assembly 42 is further configured to divide the spiral stack 26 and the freezer chamber 28 into a plurality of customized, horizontal air flow processing zones or segments, including a horizontal infeed processing zone 106 and a horizontal outfeed processing zone 110. The horizontal infeed processing zone 106 is a horizontal air flow processing zone at a top end of the spiral stack 26 in communication with the infeed 62. The horizontal infeed processing zone 106 is defined by an upper horizontal baffle 114 that extends substantially horizontally/transversely across an upper portion of the freezer chamber 28, including substantially across the entire spiral stack 26.

The upper horizontal baffle 114 extends substantially horizontally across the freezer chamber 28 and spiral stack 26 within the confines of the first and second lateral vertical baffles 80 and 84 and the front end of the spiral stack 26. In that regard, the upper horizontal baffle 114 has a shape that is substantially the same as the cross-sectional shape of the first and second lateral vertical baffles 84 and the spiral stack 26. The upper horizontal baffle 114 is located vertically within the freezer chamber 28 so as to enclose a number of stack tiers 34 between the upper horizontal baffle 114, the first and second lateral vertical baffles 80 and 84, and the relative portions of the rectangularly shaped housing 23 defining the freezer chamber 28 (specifically, the ceiling 25 and wall 29).

In some examples, the upper horizontal baffle 114 has a central, circular opening aligned with the annulus of the spiral stack 26 (e.g., defined by the substantially continuous inner cylindrical wall-like surface 32). In the example shown, the upper horizontal baffle 114 extends uninterrupted substantially horizontally/transversely across substantially the entire spiral stack 26, including across the annulus of the spiral stack 26. The configuration of the upper horizontal baffle 114 (e.g., whether it has an annulus opening) may depend on the specific freezing application or other considerations.

The upper horizontal baffle 114 is located vertically within the freezer chamber 28 so as to enclose a predetermined number of stack tiers 34 extending from the infeed 62. In other words, the infeed processing zone 106 is defined as a predetermined number of tiers at the upper end of the spiral stack 26, including the top-most tier in direct communication with the infeed 62.

The predetermined number of stack tiers 34 within the horizontal infeed processing zone 106 is dependent on the thermal processing characteristics and/or requirements of work products within the horizontal infeed processing zone. As will be discussed further below, the size of the horizontal infeed processing zone 106 is generally configured to support an amount of time needed for the work product to complete a first stage of the freezing process, assuming cooling air of a certain temperature and velocity, and other process/system specifications. In some examples, the horizontal infeed processing zone 106 is about one-sixth to one-third of the total height of the spiral stack 26. Thus, in an example where the spiral stack 26 includes thirty tiers, the horizontal infeed processing zone 106 may encompass between about five to ten tiers.

The horizontal infeed processing zone 106 receives pressurized, cold air from the gas treatment system 40. Specifically, air flows from the evaporator coils 54, passes through the narrowed space defined by the first and second lateral vertical baffles 80 and 84, and flows into the horizontal infeed processing zone 106 in a pressurized state. The pressurized, cold air flows substantially horizontally across the annular tiers in the horizontal infeed processing zone 106 and exits through the circumferential vertical baffle gap 102. In that regard, a substantially even distribution of cold, pressurized air is delivered across the height of the horizontal infeed processing zone 106.

The horizontal outfeed processing zone 110 will now be described. The horizontal outfeed processing zone 110 is a horizontal airflow processing zone at a bottom end of the spiral stack 26 in communication with the outfeed 64. The horizontal outfeed processing zone 110 is substantially similar to the horizontal infeed processing zone 106. In that regard, the horizontal outfeed processing zone 110 is defined by a lower horizontal baffle 118 that extends substantially horizontally/transversely across a lower portion of the freezer chamber 28 (in a spaced, substantially parallel relationship relative to the first horizontal baffle 114), including across substantially the entire spiral stack 26.

The lower horizontal baffle 118 extends substantially horizontally across the freezer chamber 28 and spiral stack 26 within the confines of the first and second lateral vertical baffles 80 and 84 and the front end of the spiral stack 26. In that regard, the lower horizontal baffle 118 has a shape that is substantially the same as the cross-sectional shape of the first and second lateral vertical baffles 84 and the spiral stack 26 (and substantially the same shape as the upper horizontal baffle 114). The lower horizontal baffle 118 is located vertically within the freezer chamber 28 so as to enclose a predetermined number of stack tiers 34 between the lower horizontal baffle 118, the first and second lateral vertical baffles 80 and 84, and the relative portions of the rectangularly shaped housing 23 defining the freezer chamber 28 (specifically, the floor 33 and wall 29).

In some examples, the lower horizontal baffle 118 has a central, circular opening aligned with the annulus of the spiral stack 26 (e.g., defined by the substantially continuous inner cylindrical wall-like surface 32). In the example shown, the lower horizontal baffle 118 extends uninterrupted substantially horizontally/transversely across substantially the entire spiral stack 26, including across the annulus of the spiral stack 26. The configuration of the lower horizontal baffle 118 (e.g., whether it has an annulus opening) may depend on the specific freezing application or other considerations.

The lower horizontal baffle 118 is located vertically within the freezer chamber 28 so as to enclose a predetermined number of stack tiers 34 extending from the outfeed 64. The predetermined number of stack tiers 34 within the horizontal outfeed processing zone 110 is dependent on the thermal processing characteristics and/or requirements of work products within the horizontal outfeed processing zone. As will be discussed further below, the size of the horizontal outfeed processing zone 110 is generally configured to support an amount of time needed for the work product to complete a final stage of the freezing process, assuming cooling air of a certain temperature and velocity, among other process/system specifications. In some examples, the horizontal outfeed processing zone 110 is about one-sixth to one-third of the total height of the spiral stack 26. Thus, in an example where the spiral stack 26 includes thirty tiers, the horizontal outfeed processing zone 110 may encompass between about five to ten tiers.

The horizontal infeed and outfeed processing zones 106 and 110 receive pressurized, cold air from the gas treatment system 40. Specifically, air flows from the evaporator coils 54, passes through the narrowed space defined by the second vertical baffle portion 92 of the first and second lateral vertical baffles 80 and 84, and flows into the infeed and outfeed processing zones 106 and 110 in a pressurized state. The pressurized, cold air flows substantially horizontally across the height of each of the infeed and outfeed processing zones 106 and 110 or across all the annular tiers in the infeed and outfeed processing zones.

Moreover, as the work products are rotated about the tiers in the infeed and outfeed processing zones 106 and 110, all the work products pass by the inlet of pressurized cold air horizontally entering the respective zones. In that regard, substantially the entirety of the work products in the infeed and outfeed processing zones 106 and 110 are covered in cold, high velocity air as they move throughout the spiral stack 26.

The velocity of the cold air through the infeed and outfeed processing zones 106 and 110 can be modified to accommodate the first and last stages of the work product freezing process. Specifically, the velocity can be increased or decreased to accommodate a rate of heat transfer between the air and the work product, a size of the infeed and outfeed processing zones 106 and 110 needed to support the first or last stage in the freezing process, a size or weight of the work product, etc. For instance, if the work product would benefit from a more rapid rate of heat transfer in the first or last stage, the velocity may be increased.

The velocity may be increased or decreased by adjusting a position of one or more portions of the airflow directing assembly 42. For instance, the vertical position of the upper horizontal baffle 114 may be adjusted to increase or decrease the velocity in the infeed processing zone 106. If the upper horizontal baffle 114 is moved upwardly, the height of the infeed processing zone 106 decreases, and the same volume of air is forced to flow through the infeed processing zone 106, now smaller in size. Thus, moving the upper horizontal baffle 114 upwards increases the air velocity in the infeed processing zone 106. Moving the upper horizontal baffle 114 vertically downward would decrease the velocity in the infeed processing zone 106.

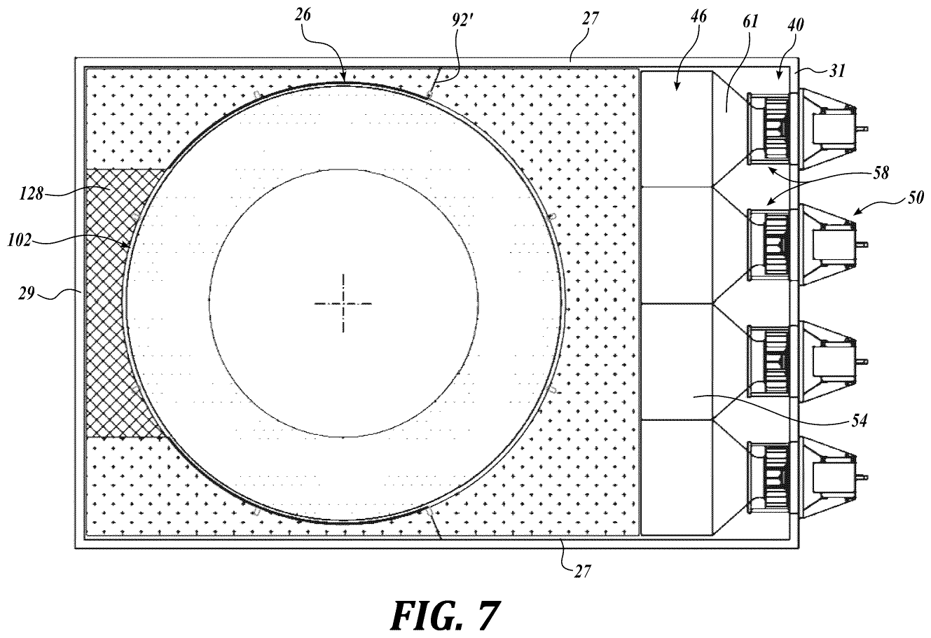

In some examples, the angled position of the second vertical baffle portion 92 of one or more of the first and second lateral vertical baffles 80 and first and second lateral vertical baffles 84 may be adjusted to increase or decrease the size of the nozzle defined by those portions. Increasing or decreasing the nozzle size defined by the first and second lateral vertical baffles 80 and first and second lateral vertical baffles 84 would correspondingly decrease and increase the air velocity entering the infeed processing zone 106. For instance, in the example shown in FIG. 7, a second vertical baffle portion 92′ is at a location that creates a wider/larger nozzle.

The air velocity in the outfeed processing zone 110 may be similarly adjusted by changing the vertical height of the lower horizontal baffle 118 and/or one or more of the first and second lateral vertical baffles 80 and 84.

As noted above, increasing the air velocity in the infeed and outfeed processing zones 106 and 110 can increase the heat transfer rate between the cold air and the work product in those zones. Such increased heat transfer rate may be balanced with the ability of the work product to withstand higher air velocities, the requirements of intermediary and final stages of the freezing process, the resulting work product quality (a more rapid rate of heat transfer may cause surface damage or other adverse effects), etc. For instance, smaller work products that are low in weight may not be able to endure higher air velocities without moving or shifting on the conveyor belt. Further, higher air velocities may damage a coating, sauce, etc., on the work products.

The pressurized, cold air flows substantially horizontally across all of the annular tiers in the infeed and outfeed processing zones 106 and 110 and exits through the circumferential vertical baffle gap 102 extending along each zone. After exiting the infeed and outfeed processing zones 106 and 110, the air flows into infeed and outfeed return zones 122 and 126, respectively, located immediately below and above the infeed and outfeed processing zones 106 and 110. Air flows through the return zones 122 and 126 and returns to the gas treatment system 40.

In the depicted example, the infeed return zone 122 is defined by the tiers 34 of the spiral stack 26 located beneath the upper horizontal baffle 114 and above an intermediate horizontal baffle 128. Likewise, the return zone 126 is defined by the tiers 34 of the spiral stack 26 located above the lower horizontal baffle 118 and below the intermediate horizontal baffle 128. In some examples, the intermediate horizontal baffle 128 may additionally be considered a mezzanine suitable for supporting personnel, equipment, etc., such as for cleaning, maintenance, repair, etc.

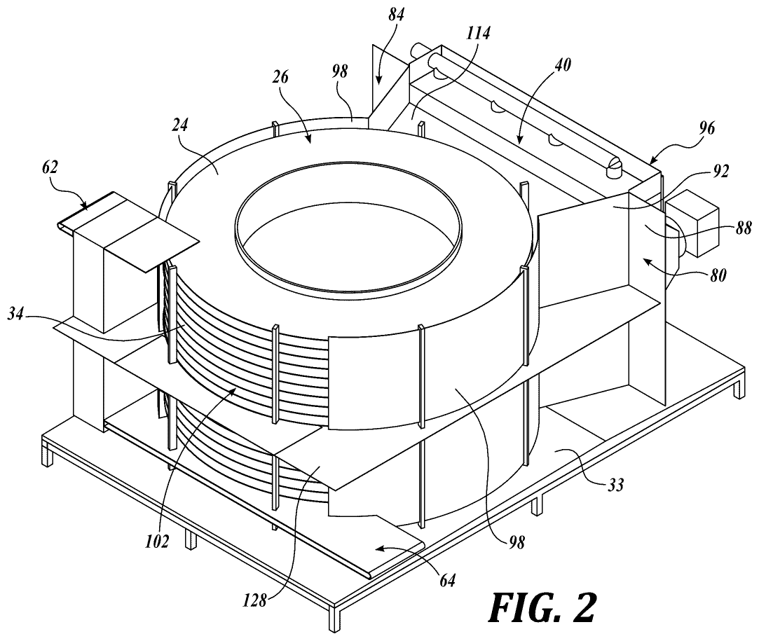

In some examples, the intermediate horizontal baffle 128 extends substantially horizontally across the freezer chamber 28 between the longitudinal side walls 27 and between the wall 29 and the evaporator coils 54/first vertical baffle portion 88 of the gas treatment system baffle assembly 96 (see FIG. 2). A vertical baffle may also extend along each side of the circumferential vertical baffle gap 102 (or in a location nearby) to substantially prevent air from flowing into the space of the freezer chamber 28 between the exterior of the first and second lateral vertical baffles 80 and 84 and the longitudinal side walls 27 of the rectangularly shaped housing 23. In that manner, the return air is most efficiently directed back to the gas treatment system 40.

In any event, the intermediate horizontal baffle 128 may or may not extend across the annular opening of the spiral stack 26. In the example shown in FIGS. 1-5, the intermediate horizontal baffle 128 extends across the tiers of the spiral stack 26 but does not extend across the annular opening of the stack. In this manner, return air flowing into the return zone 122 may combine or mix with return air flowing into the return zone 126. In some examples, the intermediate horizontal baffle 128 does not extend across the tiers at the rear of the spiral stack 26 (near the evaporator coils 54) to support further mixing of the return air flowing in the return zones 122 and 126 before reaching the evaporator coils 54. In yet further examples, the intermediate horizontal baffle 128 is excluded to allow complete mixing of return air in a single intermediate return zone defined between the infeed and outfeed processing zones 106 and 110.

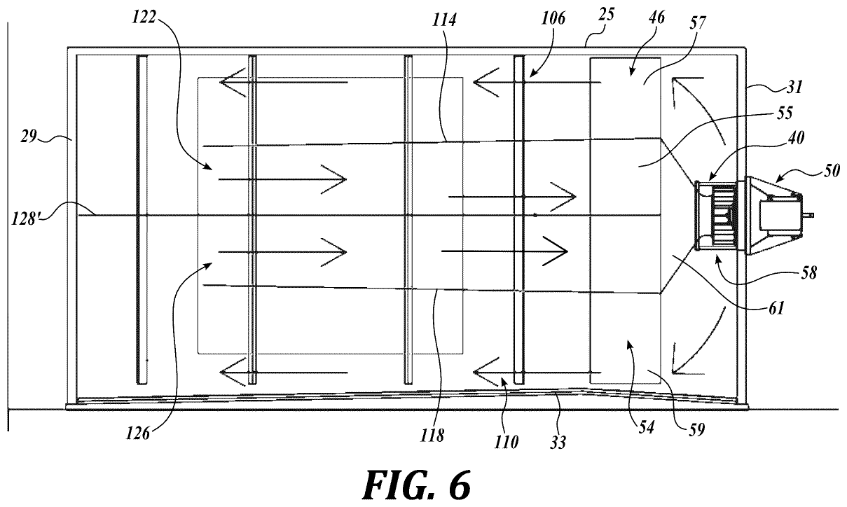

In an alternate example shown in FIG. 6, the intermediate horizontal baffle 128′ extends entirely across the freezer chamber 28 and the tiers of the spiral stack 26, including across the annular opening of the stack. Such a configuration substantially prevents mixing of air returning from the infeed and outfeed processing zones 106 and 110. The configuration of the intermediate horizontal baffle 128 may depend on the specific freezing application or other considerations.

Regardless of the exact configuration of the intermediate horizontal baffle 128, the air is drawn into the return zones 122 and 126 by a combination of the positive air pressure in the infeed and outfeed processing zones 106 and 110 and negative air pressure in the return zones 122 and 126. Negative air pressure is generated by the force of the fan wheels 58 of the gas circulation assembly 50. The fan wheels 58 draw air from the return zones 122 and 126 across the evaporator coils 54 for cooling and recirculation of the air to the infeed and outfeed processing zones 106 and 110.

Return air flows from the return zones 122 and 126 across a primary cooling portion 55 of the evaporator assembly 46 defined generally between the upper horizontal baffle 114 and lower horizontal baffle 118. The return air is primarily cooled by the primary cooling portion 55 of the evaporator assembly 46. The fan wheels 58 move the primarily cooled air within a primary cooling chamber 134 defined between the evaporator assembly 46, the gas treatment system baffle assembly 96, and the interior of the rectangularly shaped housing 23. In one example, the fan wheels 58 move the air centrifugally away from the primary cooling portion of the evaporator coils 54.

The force of the fan wheels 58 increases the air pressure within the primary cooling chamber 134 and forces the primarily cooled air to pass back through the evaporator coils 54 in upper and lower secondary cooling portions 57 and 59 (of the evaporator coils 54, which may include booster evaporators. Air that passes back through the upper and lower secondary cooling portions 57 and 59 becomes secondarily cooled air.

The upper and lower secondary cooling portions 57 and 59 of the evaporator coils 54 are generally aligned with the infeed and outfeed processing zones 106 and 110, respectively. Accordingly, secondarily cooled air flows into and through the infeed and outfeed processing zones 106 and 110 from the pressure of the fan wheels 58 and treats work products on the tiers in those zones.

The volume of air flowing through the variable bi-directional airflow thermal processing system 60 remains substantially the same regardless of the location of the upper horizontal baffle 114, the lower horizontal baffle 118, or the intermediate horizontal baffle 128 (assuming no change in the gas treatment system 40 or gas circulation assembly 50 that affect the volume of air flow). In that regard, the volume of air flowing through the infeed and outfeed processing zones 106 and 110 may be understood to be substantially equal to the volume of air flowing through the return zones 122 and 126. The volumetric air flow remains balanced in this manner regardless of how the velocities in those zones are changed by modifying the vertical location of the baffles 114, 118, and/or 128.

The evaporator design of the variable bi-directional airflow thermal processing system 60 provides many advantages. In one aspect, frost buildup will likely occur almost exclusively on the primary cooling portion 55 of the evaporator assembly 46. In that regard, defrost design considerations can be focused on or only applied to the primary cooling portion 55. In further aspects, a geometry of the upper and lower secondary cooling portions 57 and 59 may be configured to force the air distribution substantially evenly across the entire plane of the secondary cooling portions, as noted above. Such substantially uniform air distribution results in more consistent velocities entering the infeed and outfeed processing zones 106 and 110.

In further aspects, the available evaporator space increases as the size of the spiral stack increases. In that regard, when heat load requirements increase due to an increase stack size, the evaporator tonnage from the evaporator may be correspondingly increased. In other words, the overall freezer system has a footprint and capacity that corresponds to the thermal processing needs of the system.

In yet further aspects, the evaporator design of the variable bi-directional airflow thermal processing system 60 supports both ascending or descending spiral designs. Because the evaporator configuration is symmetrical (i.e., the upper secondary cooling portion 57 is substantially identical to the lower secondary cooling portion 59), it can be adapted to both ascending and descending spiral designs without significant design changes.

The air flows substantially horizontally across the infeed and outfeed processing zones 106 and 110 as the work products travel along a generally horizontal path of the spiral stack 26. In that regard, a shift in the work product position/orientation occurs within the spiral stack 26 as the spiral conveyor continuously moves during the freezing process. Thus, the airflow direction remains substantially constant across the infeed and outfeed processing zones 106 and 110 while the position/orientation of the work product continuously changes. In that regard, the airflow constantly hits the work products at different angles within the infeed and outfeed processing zones 106 and 110, increasing heat transfer efficiency. By comparison, a vertical airflow design directs airflow at only the top and/or bottom surface of the product.

The secondarily cooled air, also referred to herein as high velocity cooled air or the like, is substantially evenly distributed across the height and width of the infeed and outfeed processing zones 106 and 110. In that regard, the horizontal airflow performs a concurrent sweep of top and bottom surfaces of all the work products on all the tiers in the processing zone as they move within the spiral. Such a substantially even distribution of high velocity cooled air may be defined at least in part by the configuration of the gas treatment system 40 and gas circulation assembly 50. For instance, the evaporator coils 54 of the gas treatment system 40 are arranged across the height and width of the freezer chamber 28 and are sufficient in number and capacity to receive and cool the primarily cooled air and supply the required secondarily cooled air.

The corresponding fan wheels 58 of the gas circulation assembly 50 are arranged across the width of the freezer chamber 28 and are sufficient in number and capacity to withdraw return air through the evaporator coils 54 across the width of the return zones 122 and 126. The fan wheels 58 are also configured to move the primarily and secondarily cooled air substantially evenly across the height and width of the respective portions 55, 57, and 59 of the evaporator coils 54 and into the infeed and outfeed processing zones 106 and 110.

The fan wheels 58 force the primarily cooled air through the upper and lower secondary cooling portions 57 and 59 of the evaporator coils 54 across their width at a sufficiently high pressure (also defined in part by the first and second lateral vertical baffles 80 and 84 and other impermeable or semi-permeable structure). In this manner, the secondarily cooled air is necessarily spread out substantially evenly across the height and width of the infeed and outfeed processing zones 106 and 110, respectively. Moreover, the upper and lower secondary cooling portions 57 and 59 of the evaporator coils 54 preferably have a geometry configured to support distribution of the secondarily cooled air substantially evenly across the entire vertical plane of the infeed and outfeed processing zones 106 and 110.

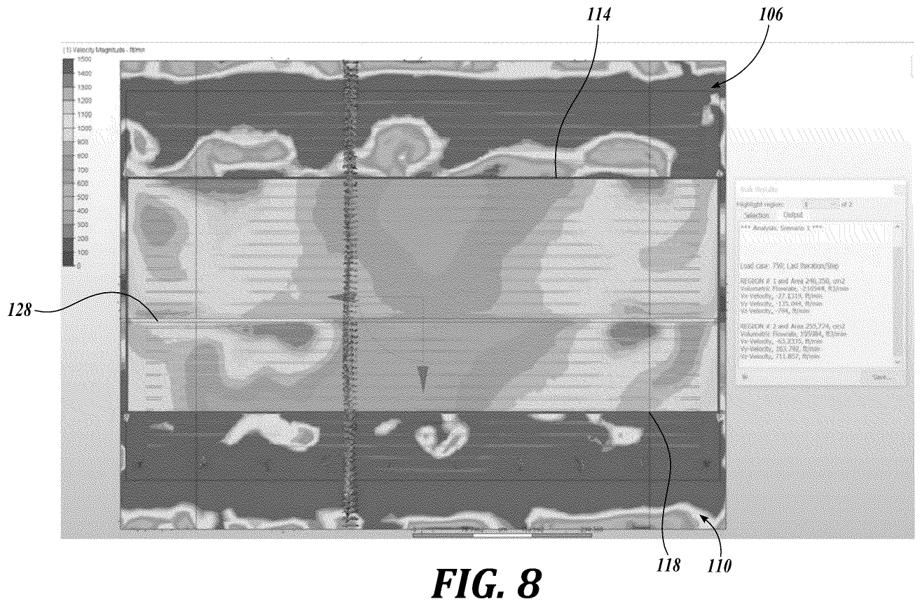

With the secondarily cooled air substantially evenly distributed across the height and width of the infeed and outfeed processing zones 106 and 110, substantially all the work products on every tier within the infeed and outfeed processing zones 106 and 110 are exposed to the high velocity, secondarily cooled air at constantly changing airflow angles. FIG. 8 shows expected face airflow velocities through evaporator coils of an exemplary variable bi-directional airflow thermal processing system based on a CFD analysis. As can be seen, the expected face velocity of the secondarily cooled air is both high (dark red color) and substantially constant along the height and width in the infeed and outfeed processing zones 106 and 110. As can further be appreciated with reference to FIG. 8, the face velocity through evaporator coils of the return air in the return zones 122 and 126, although lower than in the infeed and outfeed processing zones 106 and 110, is relatively constant along its height and width in the return zones.

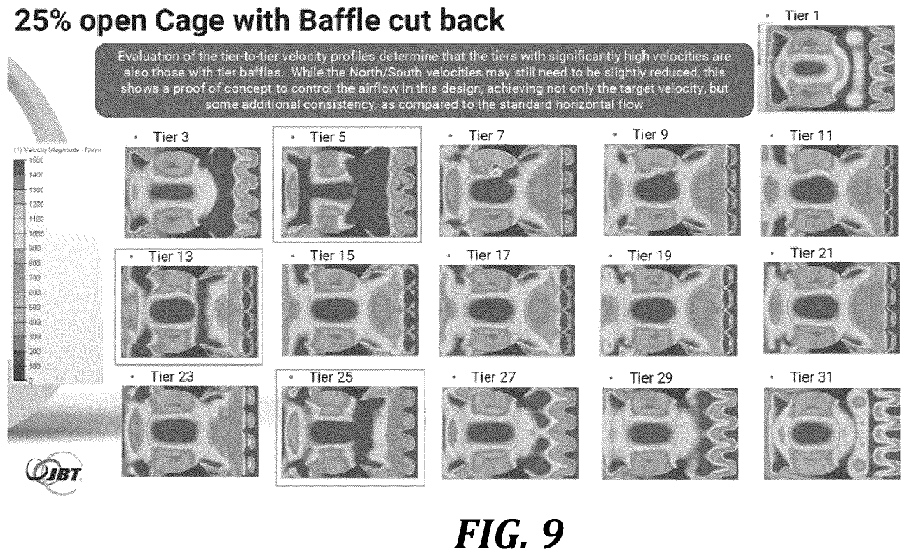

FIG. 9 shows top views of an exemplary variable bi-directional airflow thermal processing system having baffling similar to that described herein with respect to the airflow directing assembly 42, with expected airflow velocities through various tiers of the freezer chamber 28 based on a CFD analysis. As can be seen, the velocity of the secondarily cooled air is both high (dark red color) and substantially constant across the width of the infeed and outfeed processing zones 106 and 110. As can further be appreciated by the CFD image shown in FIG. 9, the velocity of the air across the width of the infeed and outfeed processing zones 106 and 110 is higher in certain tiers, with tier 5 and 25 in the respective infeed and outfeed processing zones 106 and 110 showing a high expected velocity. Moreover, there are no dead spots, or areas of no air velocity (dark blue color), for any of the tiers within the confines of the first and second lateral vertical baffles 80 and 84 across the spiral stack 26.

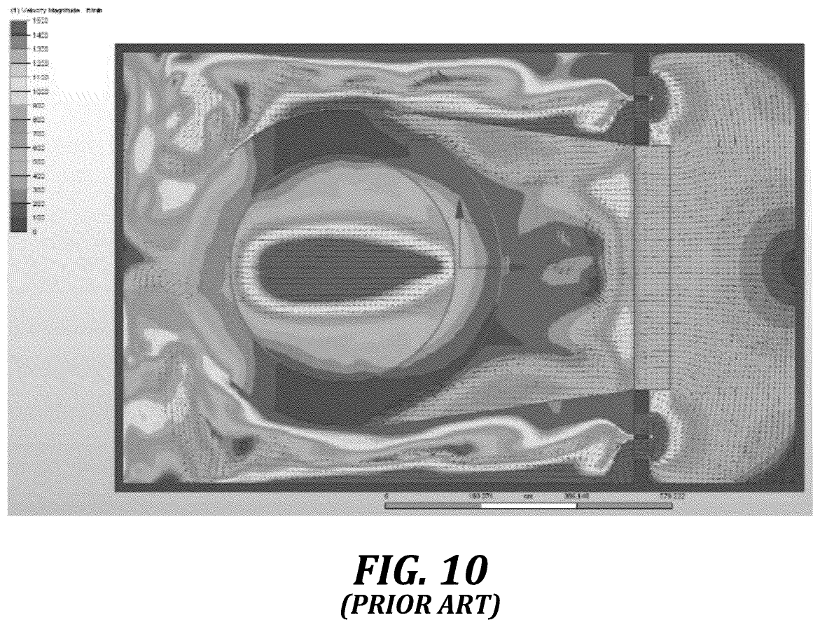

By comparison, the expected airflow velocity through a representative tier of a prior art freezer horizontal airflow design, based on a CFD analysis, is shown in FIG. 10. As can be seen, the air velocity is highest in “fan tunnels” outside of the stack, and the air velocity is lowest within the tiers of the stack. This is caused by the airflow path design, wherein the highest velocity air leaving the evaporators is first moved horizontally within of the fan tunnels on sides of the spiral stack before reaching the stack tiers in a return path. The volume of the stack is significantly larger than the volume of the fan tunnels. Accordingly, the velocity decreases significantly when it enters the stack. In fact, the representative tier in the prior art freezer horizontal airflow design has many areas of little to no air velocity.

In the variable bi-directional airflow thermal processing systems and methods disclosed herein, on the other hand, the coldest, highest velocity air coming from the evaporator flows directly into the horizontal infeed and outfeed processing zones 106 and 110, substantially uninterrupted and evenly distributed. Thus, the stack receives the coldest, highest velocity air. In the prior art design discussed above with respect to FIG. 10, the coldest, highest velocity air does not directly flow into the stack. Rather, the air must travel in the fan tunnels across substantially the entire freezer chamber before entering the stack.

Moreover, in the prior art design, the work products are only treated in one direction of airflow (and specifically, in the return direction). By contrast, using the variable bi-directional airflow thermal processing systems and methods disclosed herein, the work products are treated in both first and second airflow directions. Specifically, the air coming from the evaporator treats work products as it flows into the horizontal infeed and outfeed processing zones 106 and 110 of the stack, and air returning through the horizontal path of the return zones 122 and 126 also treats work products in those zones. In that regard, the air treats the work products during substantially the entire flow path within the freezer chamber, adding to efficiency of the design. In other words, heat transfer can occur during substantially all portions of the airflow travel inside the freezer chamber 28. Moreover, space is not needed outside the stack for returning the air, reducing the overall footprint of the freezer system. The short, direct return path of the return zones 122 and 126 also helps prevent a significant drop in pressure that would typically affect airflow velocities in the treatment areas.

As noted above, the variable bi-directional airflow thermal processing systems and methods disclosed herein enable maximization of heat transfer between the work product and the gaseous cooling medium by tailoring treatment of the work product to its stage in the freezing process. In order to appreciate these aspects of the exemplary variable bi-directional airflow thermal processing system described herein, an overview of a typical food freezing process and how it corresponds to and is supported by the zones of the variable bi-directional airflow thermal processing system 60 will now be provided.

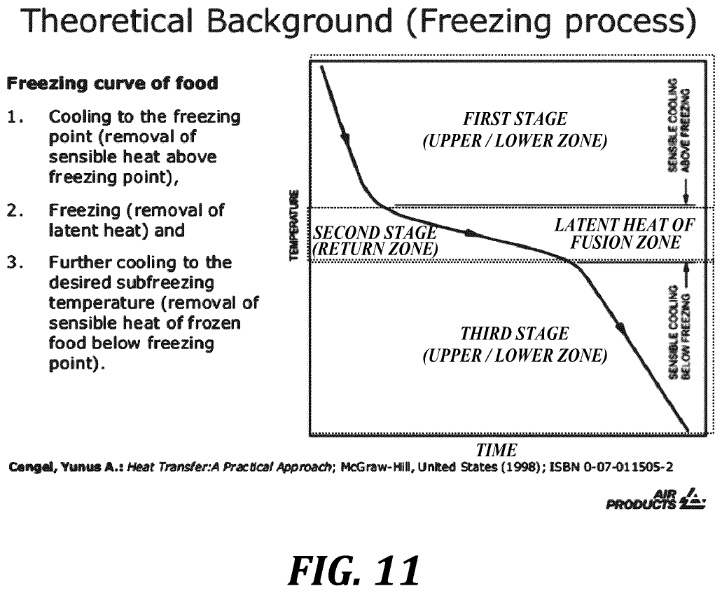

FIG. 11 provides an annotated graphical depiction or curve of a typical food freezing process based on known principles of heat transfer, with temperature on the y-axis and time on the x-axis. Different foods require different freezing temperatures and have different complexities, but they all generally adhere to a basic freeze curve as shown.

A first stage of freezing typically occurs when a food product is first subjected to a low temperature. In this first stage, sensible heat is rapidly removed from the food product, and the food product is cooled from an initial temperature to the freezing point. The graphical profile of this first stage is shown as a rapid drop in temperature over a short period of time.

This first stage of freezing generally corresponds to the infeed processing zone 106 (e.g., the upper or lower zone of the spiral stack 26, depending on spiral direction). In the infeed processing zone 106, as described above, the entirety of the first or last few tiers (or upper or lower most tiers) are covered with cold, high velocity air. The products travel within the infeed processing zone 106 a sufficient time to substantially allow for completion of the first stage of freezing. As noted above, the vertical location of the upper horizontal baffle 114 can be adjusted (and/or the conveyor speed can be adjusted) to increase or decrease the time. Thus, the infeed processing zone 106 can be tailored to accommodate the first stage of freezing.

The second phase of food freezing generally includes a phase change as water within the product turns into ice. During this second phase, the rate of temperature change in the product decreases dramatically and the time at which the change occurs increases. The second phase of the typical food freezing curve shows the temperature remaining substantially constant at the freezing point for a long time as water changes to ice, which requires added energy. The constant temperature results because the hidden heat, called latent heat, must be removed before every water molecule in the food product can change its state.

The second phase of freezing generally corresponds to the return zones 122 and 126 (or simply “return zone 122/126”). By design, the return zone 122/126 is the largest of the three zones since the phase change period (or second phase of freezing) tends to take the longest for any given product. Air velocity is lower and temperature is higher in the return zone 122/126 because the velocity and temperature of the air are not as impactful during the phase change of the product. Thus, for efficiency, the cold, high velocity air is instead directed to the infeed and outfeed processing zones 106 and 110, where it is needed to complete the first and third phases of freezing.

In the third or last phase of cooling sensible heat transfer again occurs, and the food product is sub-cooled to a temperature below the freezing point. The freezing curve shows that the product is cooled well past the freezing point until a target temperature is reached. The graphical profile of the third phase is like the first phase of freezing in that the temperature change is rapid while the time element is much shorter.

The third phase of freezing generally corresponds to the outfeed processing zone 110 (e.g., the other of the upper or lower zone of the spiral stack 26, depending on spiral direction). In the outfeed processing zone 110, as described above, the entirety of the first or last few tiers (or upper or lower most tiers) are covered with cold, high velocity air. The products travel within the outfeed processing zone 110 a sufficient time to substantially allow for completion of the third stage of freezing. As noted above, the vertical location of the lower horizontal baffle 118 can be adjusted (and/or the conveyor speed can be adjusted) to increase or decrease the time. Thus, the outfeed processing zone 110 can be tailored to accommodate the third stage of freezing.

The exemplary variable bi-directional airflow thermal processing system 60 described herein generally mimics the food freezing process in a physical sense in that the infeed processing zone 106 is configured to support the first stage of freezing for a given work product, the return zone 122/126 is configured to support the second stage of freezing, and the outfeed processing zone 110 is configured to support the third and final stage of freezing. In that regard, work products spend a sufficient amount of time within the infeed processing zone 106, the return zone 122/126, and the outfeed processing zone 110 to substantially complete the first, second, and third stages of freezing for that work product, respectively. Prior art designs do not tailor thermal treatment for different stages of the work product freezing curve.

The amount of time within each zone is defined by the vertical location of the upper horizontal baffle 114 and lower horizontal baffle 118 and the conveyor size/speed. The time within a zone may be increased or decreased as needed, as described herein, depending on the freezing curve of the food product, the temperature and velocity of the airflow, and the temperature of the incoming product.

It should be noted that the incoming product temperatures carry a standard deviation constituting both machine and substrate specific components that depend on operating conditions employed upstream to process these incoming products. For instance, the incoming work products may be coming straight out of an oven or other cooking apparatus and may therefore be rather hot. In other instances, cooked work products are diverted between the cooking apparatus and the freezer and are much cooler. Therefore, the temperature deviations entering the freezer are both product and process specific, thus creating a need for a corresponding operational flexibility in the freezing zones created by the upper horizontal baffle 114 and lower horizontal baffle 118.

According to known principles of thermodynamics, maximum heat transfer occurs when a temperature difference between a moving fluid and the collective sum of the individual products' surface temperatures are the greatest. Incoming products are at their highest temperatures immediately upon entering a freezer. Thus, targeting the infeed processing zone 106 with cold, high velocity air ensures that maximum heat transfer occurs as quickly as possible in the infeed zone to ensure timely completion of the first phase of freezing. Specifically, weighted averages of the log mean temperature differentials between the cold, high velocity air and the product surface temperatures can be substantially increased to thereby improve energy transfer between the product and the air.

Similarly, targeting the outfeed processing zone 110 with cold, high velocity air ensures that maximum heat transfer occurs as quickly as possible in the outfeed zone to ensure timely completion of the third phase of freezing. Product leaving the freezer system is thus at its coldest temperatures for shipping/storage needs.

When optimizing the freezer design to maximize heat transfer, as with the variable bi-directional airflow thermal processing systems and methods described herein, the overall required dwell time of the product will go down. In that regard, faster conveyor speeds can be used and/or the spiral stack can be reduced to a smaller size and consume less space in the processing facility. Decreased dwell time correlates directly to an increase in product throughput.

Further, the variable bi-directional airflow thermal processing systems and methods described herein increase product quality and yield. Using the variable bi-directional airflow thermal processing systems and methods described herein, heat transfer occurs more uniformly across the work products in the system. As noted above, cooling air hits the work products in each of the zones in a substantially uniform manner. Regarding the infeed and outfeed processing zones 106 and 110, secondarily cooled air, or air that passes through the upper and lower secondary cooling portions 55 and 57 of the evaporator coils 54, is spread out substantially evenly across the height and width of the infeed and outfeed processing zones 106 and 110, respectively.

Moreover, as the work products are rotated about the tiers in the infeed and outfeed processing zones 106 and 110, all the work products pass by the inlet of substantially horizontally-fed, pressurized cold air. In that regard, substantially the entirety of the work products in the infeed and outfeed processing zones 106 and 110 are covered in cold, high velocity air. The same is true for the work products in the return zone 122/126, only that the temperature and velocity of the cooling air is lower than in the infeed and outfeed processing zones 106 and 110.

Further, as noted above, the angle of the cooling air stream and the product is constantly changing as the product moves through the spiral stack. Thus, the top, bottom, and sides of the products are all exposed to the cooling air throughout the cooling process. Such diversity in the angle of air exposure to the product ensures a more even freezing process than vertical airflow configurations (e.g., air flowing vertically through the entire stack), where the angle between the airflow and the product is always constant. For instance, in vertical airflow configurations, only the top surface of the product is exposed to the cooling air.

By comparison, the top, bottom, and sides of the products are all exposed to the cooling air throughout the cooling process using the bi-directional airflow thermal processing systems and methods described herein. Heat transfer efficiency of the bi-directional airflow thermal processing systems and methods described herein increases product quality. Generally, the faster a food can be frozen, the higher the quality. Moreover, if the work products are more consistently frozen during the freezing process, overall work product quality and yield increases because there are lower standard deviations of substrate temperatures.

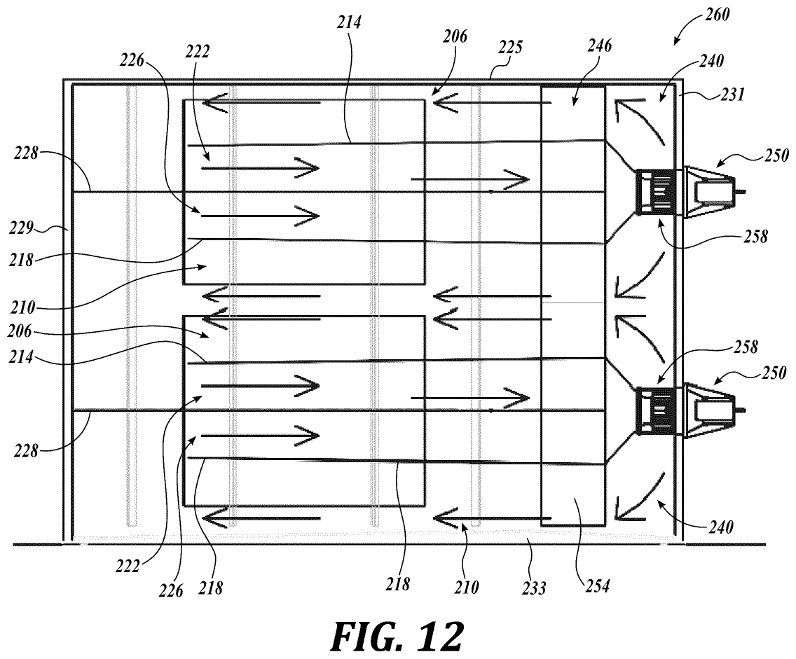

A second example of a variable bi-directional airflow thermal processing system 260 will now be described with reference to FIG. 12. The variable bi-directional airflow thermal processing system 260 has substantially identical components to the variable bi-directional airflow thermal processing system 60. Thus, like parts are labeled with the same reference numeral except in the '200 series.

The variable bi-directional airflow thermal processing system 260 may provide at least the same benefits as discussed above with respect to the variable bi-directional airflow thermal processing system 60. In addition, the variable bi-directional airflow thermal processing system 260 is configured to support increased thermal processing differentiation by incorporating additional treatment and return zones as compared to the variable bi-directional airflow thermal processing system 60. Additional treatment and return zones may be desired for larger freezer systems that process a larger quantity of work products in the spiral stack. At some point, the velocity of the airflow within the treatment and return zones (e.g., zones 106/110 and 122/126) will decrease as they increase in overall height to accommodate larger freezer systems. Splitting the stack into additional treatment and return zones allows for a smaller zone height.

The variable bi-directional airflow thermal processing system 260 may be any suitable configuration to support division of the spiral stack into various additional horizontal treatment and return zones. In the example depicted in FIG. 12, the variable bi-directional airflow thermal processing system 260 essentially includes top and bottom portions defined by two variable bi-directional airflow thermal processing systems 60 stacked vertically. In that regard, the parts that are like the variable bi-directional airflow thermal processing system 60, as described above, are labeled identically in the stacked, upper and lower portions of the variable bi-directional airflow thermal processing system 260 and are simply referred to as “top” and “bottom” parts. Moreover, the variable bi-directional airflow thermal processing system 260 may be considered a two-stage variable bi-directional airflow thermal processing system or a variable bi-directional double airflow thermal processing system.

The variable bi-directional airflow thermal processing system 260 includes a top upper horizontal baffle 214 that defines a top infeed processing zone 206, a top lower horizontal baffle 218 that defines a top outfeed processing zone 210, and a top intermediate horizontal baffle 228 that defines top return zones 222 and 226. The variable bi-directional airflow thermal processing system 260 further includes a bottom upper horizontal baffle 214 that defines a bottom infeed processing zone 206, a bottom lower horizontal baffle 218 that defines a bottom outfeed processing zone 210, and a bottom intermediate horizontal baffle 228 that defines bottom return zones 222 and 226.

Although the variable bi-directional airflow thermal processing system 260 is described as having top and bottom “infeed” and “outfeed” treatment zones, such naming it used merely for convenience. It should be understood that the top outfeed processing zone 210 is not actually at the outfeed of the stack, and the bottom infeed processing zone 206 is not actually at the infeed of the stack. Moreover, similar to the variable bi-directional airflow thermal processing system 60, the variable bi-directional airflow thermal processing system 260 supports the inverse conveyance direction with little to no changes.

An additional horizontal baffle may be disposed between the top outfeed processing zone 210 and the bottom infeed processing zone 206 to separate those treatment zones into two distinct zones. In such a configuration, the variable bi-directional airflow thermal processing system 260 separates the stack into four distinct treatment zones. However, the velocity and temperature of the air flowing into the top outfeed processing zone 210 and the bottom infeed processing zone 206 may be substantially the same, so separation of those zones may not be necessary. In such a configuration, the variable bi-directional airflow thermal processing system 260 separates the stack into three distinct treatment zones.

The middle portion of the variable bi-directional airflow thermal processing system 260 may support a longer second stage of freezing, two or more intermediate stages of freezing between the first and final stages, etc. For instance, a middle portion defined by the top outfeed processing zone 210 and the bottom infeed processing zone 206 may be used to direct high velocity, cold air to work products during a change of phase of the products to account for changing various physical properties during the change of phase. In that regard, the middle portion of the variable bi-directional airflow thermal processing system 260 may be understood to support temperature induced dynamic air flow cooling with the additional zones.

The middle portion of the variable bi-directional airflow thermal processing system 260 may support a longer second stage of freezing, two or more intermediate stages of freezing between the first and final stages, etc. For instance, a middle portion defined by the top outfeed processing zone 210 and the bottom infeed processing zone 206 may be used to direct high velocity, cold air to work products during a change of phase of the products to account for various physical properties during the change of phase. In that regard, the middle portion of the variable bi-directional airflow thermal processing system 260 may be understood to support temperature induced dynamic air flow cooling with the additional zones.

As noted above, the evaporator design of the variable bi-directional airflow thermal processing systems and methods described herein allows for scaling to accommodate a larger thermal processing system and/or requirements. In that regard, the variable bi-directional airflow thermal processing system 260 may include a corresponding increase in size of the gas treatment system 240 and gas circulation assembly 250. In the depicted example, the variable bi-directional airflow thermal processing system 260 includes a top gas treatment system 240 and top gas circulation assembly 250 configured to supply high velocity, cold air to the top infeed and outfeed processing zones 206 and 210. The variable bi-directional airflow thermal processing system 260 further includes a bottom gas treatment system 240 and bottom gas circulation assembly 250 configured to supply high velocity, cold air to the bottom infeed and outfeed processing zones 206 and 210.

In some examples, the top and bottom gas treatment systems 240 and top and bottom gas circulation assemblies 250 are the same configuration and capacity, with each having the same number/capacity of evaporators 246 and air movement devices or fans 258. In such an example, the air velocity in the top and bottom treatment zones could be substantially identical. Alternatively, the velocities in the top and bottom treatment zones 206 and 210 may be increased or decreased by changing the vertical location of the upper and lower horizontal baffles 214 and 218. In some examples, the top and bottom gas circulation assemblies 250 differ in evaporator and/or fan configuration/capacity. The top and bottom gas circulation assemblies 250 may include the same fan bolt hole pattern for case of assembly and using any suitable number of fans 258. In such an example, the velocity in the top and bottom treatment zones 206 and 210 may vary based on the fan configuration/capacity and additionally by changing the vertical location of the upper and lower horizontal baffles 214 and 218.

In other aspects, the variable bi-directional airflow thermal processing system 260 can also increase the weighted average of the log mean temperature differential between the fluid and product surface temperatures through the improved/tailored treatment in the intermediate zones, such as during a product change of phase. Further, like the variable bi-directional airflow thermal processing system 60, variable bi-directional airflow thermal processing system 260 provides a substantially even distribution of airflow across the zones as the stack is rotating, resulting in a more uniform treatment of work products throughout the stack. As discussed above with respect to the variable bi-directional airflow thermal processing system 60, such uniform treatment reduces the average standard deviation in the substrate temperatures exiting the freezer, thereby improving product quality and increasing throughput and product yields.

The two-stage, variable bi-directional airflow thermal processing system 260 provides numerous benefits such as those described above. For instance, the variable bi-directional airflow thermal processing system 260 may support larger freezer systems without sacrificing zone size, work products with complex freezing curves, option for variability in top and bottom gas treatment systems 240, etc. The variable bi-directional airflow thermal processing system 260 may be configured to uniformly distribute high velocity, cold air to an equal number of top and bottom tiers in the top infeed and outfeed processing zones 206 and 210 and bottom infeed and outfeed processing zones 206 and 210, with process-based biasing of the middle tiers.

In other aspects, the variable bi-directional airflow thermal processing system 260 can also increase the weighted average of the log mean temperature differential between the fluid and product surface temperatures through the improved/tailored treatment in the intermediate zones, such as during a product change of phase. Further, like the variable bi-directional airflow thermal processing system 60, variable bi-directional airflow thermal processing system 260 provides a substantially even distribution of airflow across the zones as the stack is rotating, resulting in a more uniform treatment of work products throughout the stack. As discussed above with respect to the variable bi-directional airflow thermal processing system 60, such uniform treatment reduces the average standard deviation in the substrate temperatures exiting the freezer, thereby increasing the product quality and yield.

Further, with separate top and bottom gas treatment systems 240 for treating the top and bottom zones, the variable bi-directional airflow thermal processing system 260 supports front or back conveyor biased product/process specific loading through, for instance, VFD control of the stack conveyor.

Using VFD-controlled fans and/or a VFD-controlled stack conveyor supports flexibility in treatment of work products and the ability to tailor a freezing treatment with advanced process controls. Power consumption from the fans and conveyor drive systems can be monitored and controlled with intelligent process control platforms. For instance, fans and conveyor drive systems may be automatically adjusted in speed to accommodate a specific change of phase requirement, a conveyor loading configuration, etc.

The variable bi-directional airflow thermal processing system 260 can also limit frost build up to a smaller section of the top and bottom gas treatment systems 240. By defining two upper return zone stages, as with top return zones 222 and 226, the number of tiers in the top return zone 222 immediately following the top infeed processing zone 206 is reduced, such as compared to the designs described above with reference to FIGS. 1-7. Return airflow approaching the evaporators 246 that is preceded by treatment of work products within the first stage is confined to the top return zone 222. Frost buildup will likely occur almost exclusively on the upper evaporators 246 in the top return zone 222 immediately following first phase work product treatment occurring in the top infeed processing zone 206, where the difference in temperature between incoming products and the cooling air is the greatest. As such, defrost design considerations may only need to be applied to the narrow return zone 122. Controlling frost build up can lead to improving run time between defrost cycles.

The foregoing benefits with respect to process considerations during products' change of phase related to both the characterization and distribution of air flow described in the exemplary single-stage variable bi-directional airflow thermal processing system 60, the two-stage variable bi-directional airflow thermal processing system 260, or combinations thereof are uniquely positioned to take advantage of variants associated with loading, product and process specificity, and the changes in thermal properties that apply above, during and below freezing temperatures of substrates.

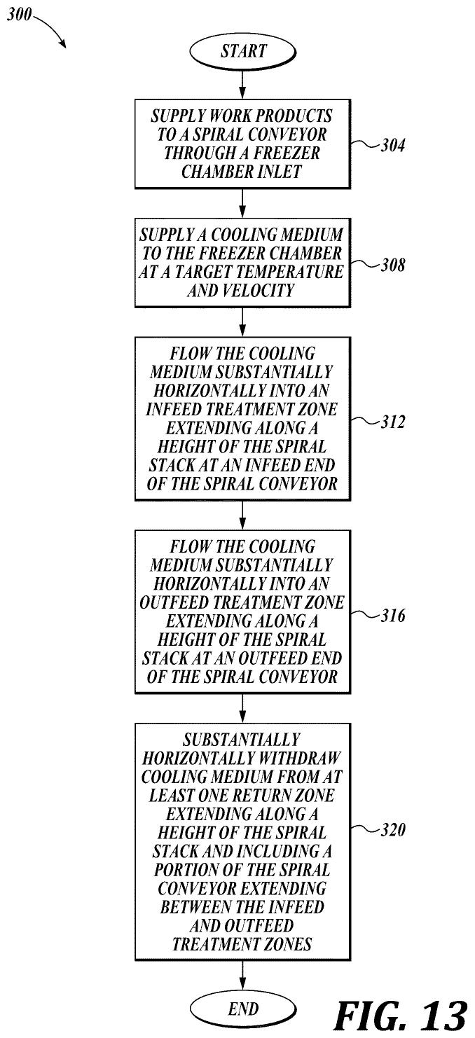

FIG. 13 is a flowchart of an example method 300 for treating work products in spiral conveyor freezer having a spiral conveyor configured in a spiral stack and enclosed within a freezer chamber. The exemplary method 300 may be used to tailor treatment of work products to stages of a freezing curve, as described herein. In that regard, aspects of the method 300 will be described with reference to the components and configurations of the variable bi-directional airflow thermal processing system 60 and/or the variable bi-directional airflow thermal processing system 260 described herein. However, it should be appreciated that the exemplary method 300 may instead be carried out by any thermal processing component or configuration in accordance with the systems and methods described herein.

From a start block, the method 300 proceeds to block 304, where the method includes supplying work products to the spiral conveyor through a freezer chamber inlet. For instance, work products may be supplied to the infeed 62 at an uppermost tier of the spiral stack 26.

The method 300 may proceed to block 308, where the method includes supplying a cooling medium to the freezer chamber at a target temperature and velocity. The cooling medium may be supplied by the evaporator assembly 46 and fan wheels 58 (or evaporators 246 and fan wheels 258).

The method 300 may proceed to block 312, where the method includes flowing the cooling medium substantially horizontally into an infeed treatment zone extending along a height of the spiral stack at an infeed end of the spiral conveyor. For instance, the cooling medium, which is cold, high velocity air, flows substantially horizontally into infeed treatment zone 106 or 206.

The method 300 may proceed to block 316, where the method includes flowing the cooling medium substantially horizontally into an outfeed treatment zone extending along a height of the spiral stack at an outfeed end of the spiral conveyor. For instance, the cooling medium, which is cold, high velocity air, flows substantially horizontally into outfeed processing zone 110 or 210.

The method 300 may proceed to block 320, where the method includes substantially horizontally withdrawing cooling medium from at least one return zone extending along a height of the spiral stack and including a portion of the spiral conveyor extending between the infeed and outfeed treatment zones. For instance, the cooling medium may be withdrawn through return zones 122/126 or return zones 222/226.

In some aspects, the method 300 further includes pressurizing the cooling medium that is substantially horizontally directed into the infeed and outfeed treatment zones. For instance, the cooling medium may first pass through the nozzle defined by the first and second lateral vertical baffles 80.

In some aspects, the method 300 further includes drawing the cooling medium into the return zone after flowing the cooling medium substantially horizontally through the infeed and outfeed treatment zones. In that regard, the fan wheels 58 or 258 may create a low pressure zone in the return zones 122/126 or 222/226 for directing air from the infeed treatment zones 106 or 206 into the return zones 122/126 or 222/226.

In some aspects, the method 300 further includes primarily cooling the cooling medium that is withdrawn from the at least one return zone and secondarily cooling the primarily cooled cooling medium for flowing substantially horizontally into the infeed and outfeed treatment zones. For instance, the air may flow through the primary cooling portion 55 of the evaporator assembly 46 and then through the upper and lower secondary cooling portions 57 and 59.

In some aspects, the method 300 further includes defining the infeed treatment zone with a first horizontal baffle extending across a width of the spiral stack (e.g., horizontal baffle 114 or 214) and adjusting a cooling medium pressure within the infeed treatment zone by adjusting a vertical location of the first horizontal baffle.

In some aspects, the method 300 further includes adjusting a time of work products within the infeed treatment zone by adjusting a vertical location of the first horizontal baffle, wherein the infeed treatment zone is sized to support a time of work products within the infeed treatment zone to substantially complete a first stage in a freezing process.

In some aspects, the method 300 further includes defining the outfeed treatment zone with a second horizontal baffle extending across a width of the spiral stack (e.g., horizontal baffle 118 or 218) and adjusting a cooling medium pressure within the outfeed treatment zone by adjusting a vertical location of the second horizontal baffle.

In some aspects, the method 300 further includes adjusting a time of work products within the outfeed treatment zone by adjusting a vertical location of the second horizontal baffle, wherein the outfeed treatment zone is sized to support a time of work products within the outfeed treatment zone to substantially complete a final stage in a freezing process.

In some aspects, the return zone (e.g., return zones 122/126 or 222/226) is sized to support a time of work products within the return zone to substantially complete an intermediate stage in a freezing process.

Various example examples of the disclosure are discussed in detail above. While specific implementations are discussed, it should be understood that this description is for illustration purposes only. A person skilled in the relevant art will recognize that other components and configurations may be used without parting from the spirit and scope of the disclosure. Thus, the description and drawings are illustrative and are not to be construed as limiting.

Numerous specific details are described to provide a thorough understanding of the disclosure. However, in certain instances, well-known or conventional details are not described in order to avoid obscuring the description. References to one or an example in the present disclosure can be references to the same example or any example; and, such references mean at least one of the example examples.

Reference to “one example” or “an example” means that a particular feature, structure, or characteristic described in connection with the example is included in at least one example of the disclosure. The appearances of the phrase “in one example” in various places in the specification are not necessarily all referring to the same example, nor are separate or alternative example examples mutually exclusive of other example examples. Moreover, various features are described which may be exhibited by some example examples and not by others. Any feature of one example can be integrated with or used with any other feature of any other example.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms.

The use of examples anywhere in this specification including examples of any terms discussed herein is illustrative only, and is not intended to further limit the scope and meaning of the disclosure or of any example term. Likewise, the disclosure is not limited to various example examples given in this specification.

Without intent to limit the scope of the disclosure, examples of instruments, apparatus, methods and their related results according to the example examples of the present disclosure are given. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure are set forth in the description, and in part will be obvious from the description, or can be learned by practice of the herein disclosed principles. The features and advantages of the disclosure can be realized and obtained by means of the instruments and combinations particularly pointed out in the appended claims.

For clarity of explanation, in some instances the present technology may be presented as including individual functional blocks representing devices, device components, steps or routines in a method embodied in software, or combinations of hardware and software.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative figures. Additionally, the inclusion of a structural or method feature in a particular figure is not meant to imply that such feature is required in all examples and, in some examples, it may not be included or may be combined with other features.

While the concepts of the present disclosure are susceptible to various modifications and alternative forms, specific examples thereof have been shown by way of example in the drawings and are described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

While illustrative examples have been illustrated and described, it will be appreciated that various changes can be made therein without departing from the spirit and scope of the invention.

1. A variable bi-directional airflow thermal processing system for a spiral conveyor configured in at least one spiral stack enclosed within a thermal processing chamber having in inlet and an outlet, the spiral conveyor entering the thermal processing chamber via the chamber inlet and exiting the thermal processing chamber via the chamber outlet, the variable bi-directional airflow thermal processing system comprising:
a thermal processing medium supply for substantially horizontally supplying thermal processing medium to the thermal processing chamber at a target temperature and velocity; and
a thermal processing medium directing assembly configured to divide the spiral stack into at least one treatment zone and at least one return zone both extending along a height of the spiral stack and substantially confined within a footprint of the spiral stack,
wherein the thermal processing medium supply substantially horizontally supplies thermal processing medium to the at least one treatment zone and substantially horizontally withdraws thermal processing medium from the at least one return zone.

2. The variable bi-directional airflow thermal processing system of claim 1, wherein the thermal processing medium directing assembly includes a first horizontal baffle extending between the thermal processing medium supply and a front end of the spiral stack and a second horizontal baffle extending between the thermal processing medium supply and a front end of the spiral stack and in a spaced, substantially parallel relationship relative to the first horizontal baffle, the first and second horizontal baffles located vertically along the stack to define a height of the at least one treatment zone and the at least one return zone.

3. The variable bi-directional airflow thermal processing system of claim 1, wherein the thermal processing medium directing assembly includes a first lateral vertical baffle extending from the thermal processing medium supply toward a front end of the spiral stack and a second lateral vertical baffle opposite the first lateral vertical baffle and extending from the thermal processing medium supply toward a front end of the spiral stack.

4. The variable bi-directional airflow thermal processing system of claim 3, wherein the first and lateral vertical baffles each include a first baffle portion extending from the thermal processing medium supply substantially radially toward the spiral stack and a second baffle portion extending from the first baffle portion along an exterior of the spiral stack, wherein the first baffle portions of the first and second lateral vertical baffles pressurize the thermal processing medium after exiting the thermal processing medium supply and before reaching the spiral stack.

5. The variable bi-directional airflow thermal processing system of claim 4, wherein the second baffle portions of the first and second lateral vertical baffles terminate before a front end of the spiral stack and define a circumferential vertical baffle gap configured to facilitate flow of thermal processing medium from the at least one treatment zone into the at least one return zone.

6. The variable bi-directional airflow thermal processing system of claim 1, wherein the thermal processing medium supply includes a fan assembly and an evaporator assembly located between the spiral stack and the fan assembly, the evaporator assembly having a primary cooling portion positioned to cool thermal processing medium that is withdrawn from the at least one return zone by the fan assembly and a secondary cooling portion positioned to cool thermal processing medium that is supplied to the at least one treatment zone by the fan assembly.

7. The variable bi-directional airflow thermal processing system of claim 1, wherein the thermal processing medium directing assembly divides the spiral stack into an infeed treatment zone, an outfeed treatment zone, and a return zone each extending along a height of the spiral stack and substantially confined within a footprint of the spiral stack, wherein the infeed treatment zone includes a portion of the spiral conveyor entering the thermal processing chamber via the chamber inlet, the outfeed treatment zone includes a portion of the spiral conveyor exiting the thermal processing chamber via the chamber outlet, and the return zone includes a portion of the spiral conveyor extending between the infeed and outfeed treatment zones.

8. The variable bi-directional airflow thermal processing system of claim 7, wherein the infeed treatment zone is sized to support a time of work products within the infeed treatment zone to substantially complete a first stage in a freezing process, the outfeed treatment zone is sized to support a time of work products within the outfeed treatment zone to substantially complete a final stage in a freezing process, and the return zone is sized to support a time of work products within the return zone to substantially complete an intermediate stage in a freezing process.

9. The variable bi-directional airflow thermal processing system of claim 7, wherein the infeed treatment zone is sized to define a first thermal processing medium pressure through the infeed treatment zone that is higher than a second thermal processing medium pressure through the return zone.

10. The variable bi-directional airflow thermal processing system of claim 7, wherein the outfeed treatment zone is sized to define a third thermal processing medium pressure through the outfeed treatment zone that is higher than a second thermal processing medium pressure through the return zone.

11. The variable bi-directional airflow thermal processing system of claim 8, wherein the thermal processing medium supply includes a fan assembly and an evaporator assembly located between the spiral stack and the fan assembly, the evaporator assembly having a primary cooling portion positioned to cool thermal processing medium that is withdrawn from the return zone by the fan assembly, a first secondary cooling portion positioned to cool thermal processing medium that is supplied to the infeed treatment zone by the fan assembly, and a second secondary cooling portion positioned to cool thermal processing medium that is supplied to the outfeed treatment zone by the fan assembly.

12. The variable bi-directional airflow thermal processing system of claim 11, wherein the evaporator assembly includes evaporator coils that extend substantially along a combined height of the infeed treatment zone, the outfeed treatment zone, and the return zone.

13. The variable bi-directional airflow thermal processing system of claim 12, further comprising a primary cooling chamber defined between the evaporator assembly and a portion of the thermal processing chamber, wherein the fan assembly is disposed within the primary cooling chamber and is configured to direct air that is withdrawn from the return zone and cooled by the primary cooling portion towards the first and second secondary cooling portions.

14. The variable bi-directional airflow thermal processing system of claim 1, wherein the thermal processing medium directing assembly divides the spiral stack into at least first, second, and third treatment zones and at least first and second return zones each extending along a height of the spiral stack and substantially confined within a footprint of the spiral stack, wherein the at least first and second return zones are alternately arranged with the at least first, second, and third treatment zones.

15-18. (canceled)

19. A variable bi-directional airflow freezer system for a spiral conveyor configured in at least one spiral stack enclosed within a freezer chamber having an inlet and an outlet, the spiral conveyor entering the freezer chamber via the chamber inlet and exiting the freezer chamber via the chamber outlet, the variable bi-directional airflow freezer system comprising:
a cooling medium supply for substantially horizontally supplying cooling medium to the freezer chamber at a target temperature and velocity; and
a cooling medium directing assembly configured to divide the spiral stack into at least an infeed treatment zone, an outfeed treatment zone, and a return zone each extending along a height of the spiral stack and substantially confined within a footprint of the spiral stack, wherein the infeed treatment zone includes a portion of the spiral conveyor entering the freezer chamber via the chamber inlet, the outfeed treatment zone includes a portion of the spiral conveyor exiting the freezer chamber via the chamber outlet, and the return zone includes a portion of the spiral conveyor extending between the infeed and outfeed treatment zones;
wherein the cooling medium supply substantially horizontally supplies cooling medium to the infeed and outfeed treatment zones and substantially horizontally withdraws cooling medium from the at least one return zone.

20. The variable bi-directional airflow freezer system of claim 19, wherein the cooling medium directing assembly includes a first horizontal baffle extending between the cooling medium supply and a front end of the spiral stack and a second horizontal baffle extending between the cooling medium supply and a front end of the spiral stack and in a spaced, substantially parallel relationship relative to the first horizontal baffle, the first and second horizontal baffles located vertically along the stack to define a height of the at least one treatment zone and the at least one return zone.

21-24. (canceled)

25. The variable bi-directional airflow freezer system of claim 19, wherein the cooling medium directing assembly divides the spiral stack into an infeed treatment zone, an outfeed treatment zone, and a return zone each extending along a height of the spiral stack and substantially confined within a footprint of the spiral stack, wherein the infeed treatment zone includes a portion of the spiral conveyor entering the freezer chamber via the chamber inlet, the outfeed treatment zone includes a portion of the spiral conveyor exiting the freezer chamber via the chamber outlet, and the return zone includes a portion of the spiral conveyor extending between the infeed and outfeed treatment zones.

26. The variable bi-directional airflow freezer system of claim 25, wherein the infeed treatment zone is sized to support a time of work products within the infeed treatment zone to substantially complete a first stage in a freezing process, the outfeed treatment zone is sized to support a time of work products within the outfeed treatment zone to substantially complete a final stage in a freezing process, and the return zone is sized to support a time of work products within the return zone to substantially complete an intermediate stage in a freezing process.

27. The variable bi-directional airflow freezer system of claim 25, wherein the infeed treatment zone is sized to define a first cooling medium pressure through the infeed treatment zone that is higher than a second cooling medium pressure through the return zone.

28-36. (canceled)

37. A spiral conveyor freezer, comprising:
a freezer chamber having an inlet and an outlet;
a spiral conveyor configured in at least one spiral stack enclosed within the freezer chamber, the spiral conveyor entering the freezer chamber via the chamber inlet and exiting the freezer chamber via the chamber outlet;
a cooling medium supply for substantially horizontally supplying cooling medium to the freezer chamber at a target temperature and velocity; and
a cooling medium directing assembly configured to divide the spiral stack into at least an infeed treatment zone, an outfeed treatment zone, and a return zone each extending along a height of the spiral stack and substantially confined within a footprint of the spiral stack, wherein the infeed treatment zone includes a portion of the spiral conveyor entering the freezer chamber via the chamber inlet, the outfeed treatment zone includes a portion of the spiral conveyor exiting the freezer chamber via the chamber outlet, and the at least one return zone includes a portion of the spiral conveyor extending between the infeed and outfeed treatment zones,
wherein the cooling medium supply substantially horizontally supplies cooling medium to the infeed and outfeed treatment zones and substantially horizontally withdraws cooling medium from the at least one return zone.

38-63. (canceled)
